(19) United States
(12) Patent Application Publication
(10) Pub. No.: US 2014/0087096 A1
(43) Pub. Date: Mar. 27, 2014

(54) Novel Covering for a Swan Hood Ornament

(71) Applicant: Patricia A. Herman, Westminster, CO (US)

(72) Inventor: Patricia A. Herman, Westminster, CO (US)

(21) Appl. No.: 14/035,360

(22) Filed: Sep. 24, 2013

Related U.S. Application Data
(60) Provisional application No. 61/744,265, filed on Sep. 24, 2012.

(51) Int. Cl. B60R 13/00

(52) U.S. Cl. CPC B60R 13/005
USPC 428/31

(57) ABSTRACT

The invention teaches clothing for a swan hood ornament. The clothing may be of a number of different types and materials such as cotton, polyester, vinyl, and vinyl coated polyester, for example. The clothing is dimensioned and configured to physically engage the hood ornament, by having spans of material sized to go around the wings and abdomen of a swan hood ornament. The clothing is further decorated with assorted nailheads, sequins, beads, buttons, decorative snaps, chains of appropriate gauge, or rhinestones.

### CLAIM OF PRIORITY

This patent application claims priority under 35 USC 119 (e) (1) from U.S. Provisional Patent Application Ser. No. 61/744,265 filed Sep. 24, 2012, of common inventorship herewith entitled, “Novel covering for a swan hood ornament. Ornament can be placed on any vehicle.”

### FIELD OF THE INVENTION

This invention pertains to the field of vehicle hood ornaments, and more specifically to a novel covering for a vehicle hood ornament, and even more specifically the field of covering for a swan hood ornament.

### BACKGROUND OF THE INVENTION

Hood ornaments on vehicles take a number of forms, some of which may be quite recognizable. Notably, some hood ornaments take the form of three dimensional metal figures rather than symbols or flat insignia. For example, the ROLLS ROYCE brand of automobiles may be sold with a figure called WINGED VICTORY, while MACK brand trucks and vehicles may be sold with the MACK bulldog. The SWAN was first used on the Packard Automobile, but is now commonly available for use on semi trucks. Such companies and figures may develop such a high degree of brand loyalty among consumers, drivers and the like that the figurines may end up being sold independently of the vehicle itself, incorporated into products such as paperweights, ash trays, or the like.

The applicant believes is not yet known to display such hood ornaments in clothing independent of the figure itself. That is, while hood ornaments may include clothing such as that of WINGED VICTORY or the studded dog collar of the MACK bulldog, the applicant believes that actually selling outfits dimensioned and configured to physically engage to the hood ornament so as to allow the hood ornament to be clothed are as yet unknown.

It would be advantageous to provide clothing for hood ornaments.

It would further be advantageous to provide clothing for hood ornaments dimensioned and configured to physically engage the hood ornament.

It would further be advantageous to provide clothing for hood ornaments which provides the hood ornaments with personality.

It would further be advantageous to provide clothing for hood ornaments which provides the hood ornaments with seasonal references.

It would further be advantageous to provide clothing for hood ornaments which provides the hood ornaments with references to the owner of the hood ornament or vehicle.

### GENERAL SUMMARY OF THE INVENTION

The present invention teaches clothing for a hood ornament such as a swan hood ornament. The clothing may be of a number of different types and materials such as but not limited to costumes, cotton, polyester, vinyl, vinyl coated polyester, Naugahyde™ brand material, truck tarp material, awning material, and other polymers.

The clothing may be dimensioned and configured to physically engage the hood ornament, for example, by having spans of material sized to go around the wings and abdomen of a swan hood ornament and by making use of snaps, hook-and-loop fastener material, hook and eye fasteners, buttons, stitching, bows, ribbons, zippers, nail heads, studs and so on.

The hood ornament clothing may provide the hood ornament so dressed with specific personality or may be seasonal in nature, such as Christmas clothing to dress the hood ornament as Santa Claus, Halloween costumes and the like, or to give to the dressed up hood ornament features or references to the owner of the hood ornament or vehicle, such as clothing indicating the personality or background of the owner, a hobby such as motorcycling, sports team, gender or the like.

### SUMMARY IN REFERENCE TO CLAIMS

It is therefore a first aspect, advantage, objective and embodiment of the invention to provide an accessory for a swan hood ornament, the accessory comprising:

an item of clothing having an appearance, the item of clothing being dimensioned to match the dimensions of such swan hood ornament, and the item of clothing being configured to match the shape of such swan hood ornament.

It is therefore another aspect, advantage, objective and embodiment of the invention to provide an accessory wherein the item of clothing comprises wing coverings and a connecting portion which connects the wing coverings across the abdomen of the swan hood ornament.

It is therefore another aspect, advantage, objective and embodiment of the invention to provide an accessory wherein the item of clothing comprises one member selected from the group consisting of: a stud, a sequin, a rhinestone, and combinations thereof. It is therefore another aspect, advantage, objective and embodiment of the invention to provide an accessory wherein the item of clothing is secured to the hood ornament by means of one member selected from the group consisting of: stitching, snaps, studs, hook-and-loop fabric, zippers, hook and eye, buttons, bows, nail heads, and combinations thereof.

It is therefore yet another aspect, advantage, objective and embodiment of the invention to provide an accessory for a swan shaped hood ornament for vehicles, the accessory comprising: an item of clothing having a first appearance, the item of clothing being dimensioned to match the dimensions of the body of a swan shaped hood ornament, and the item of clothing being configured to match the shape of the body of such swan shaped hood ornament.

### BRIEF DESCRIPTION OF THE DRAWINGS

FIG. 1 is a front perspective oblique view of an embodiment of the invention on a swan hood ornament.

FIG. 2 is a perspective rear view of an embodiment of the invention on a swan hood ornament.

FIG. 3 is a perspective front view of an embodiment of the invention.

FIG. 4 is a planform diagram of mirror images comprising the pattern embodiment of the device.

### INDEX OF REFERENCE NUMERALS

10 wing covering
22 snap
24 Center fold line
26 Abdomen covering
28 wing sew line
30 joining sew line
32 decoration such as studs, rhinestones, beads, or nailheads
50 hood ornament

### DETAILED DESCRIPTION

This design is a novelty covering for a solid metal swan hood ornament that can be mounted on any vehicle. The covering can be made from any material of choice, including, but not limited to cotton, polyester, vinyl, vinyl coated polyester, truck tarp or awning material, for example using thread of a corresponding, matching or contrasting color. Decorative items including, but not limited to, assorted nailheads, sequins, beads, buttons, decorative snaps, chains of appropriate gauge, and rhinestones may be added to enhance the covering. Placement of the decorative items on the covering can be determined by the desires and aesthetic intention of the maker of the covering.

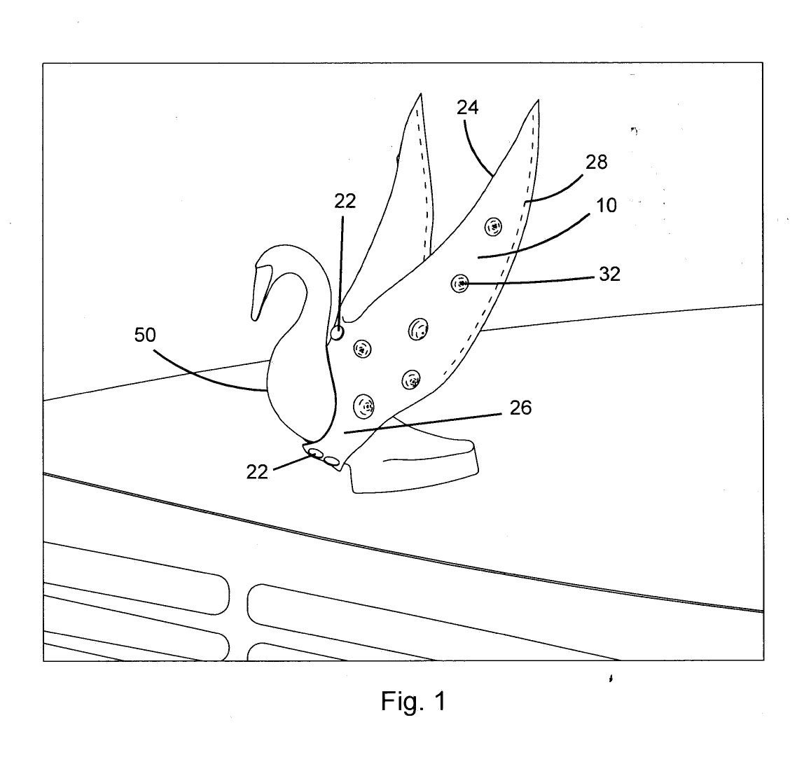

FIG. 1 is an oblique perspective view of the covering of the present invention in place on a swan hood ornament.

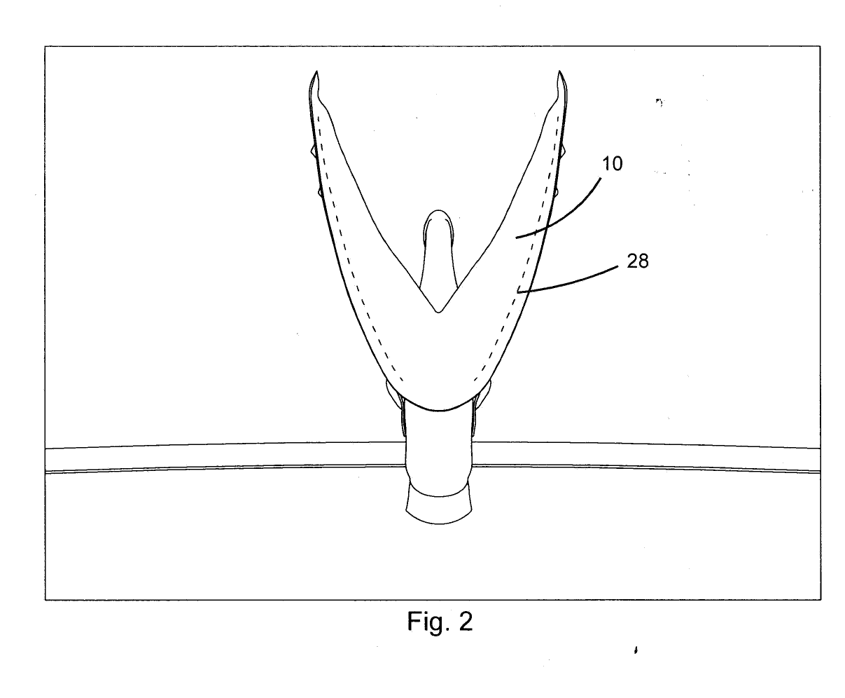

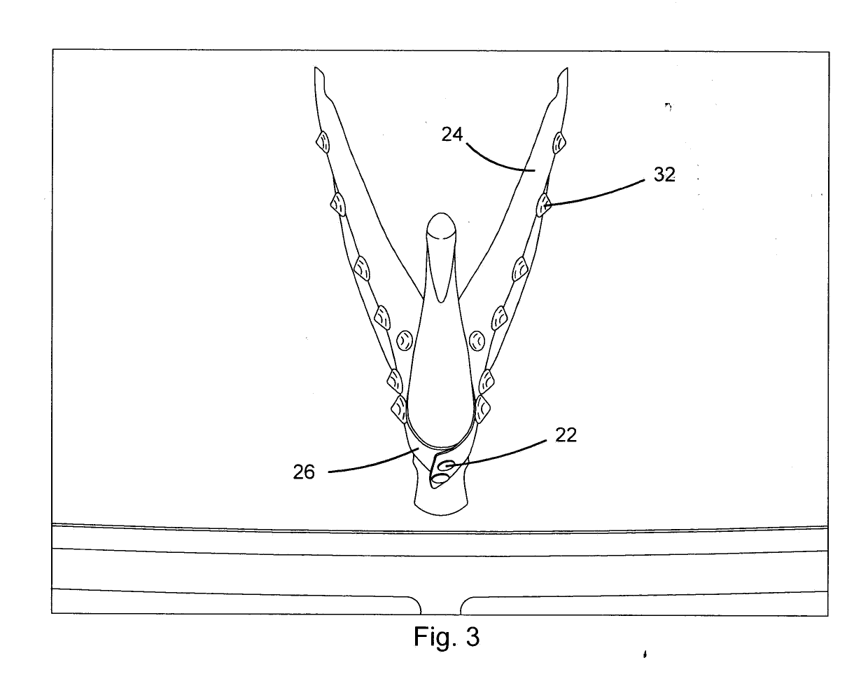

FIG. 2 is a rear view thereof and FIG. 3 is a front view thereof.

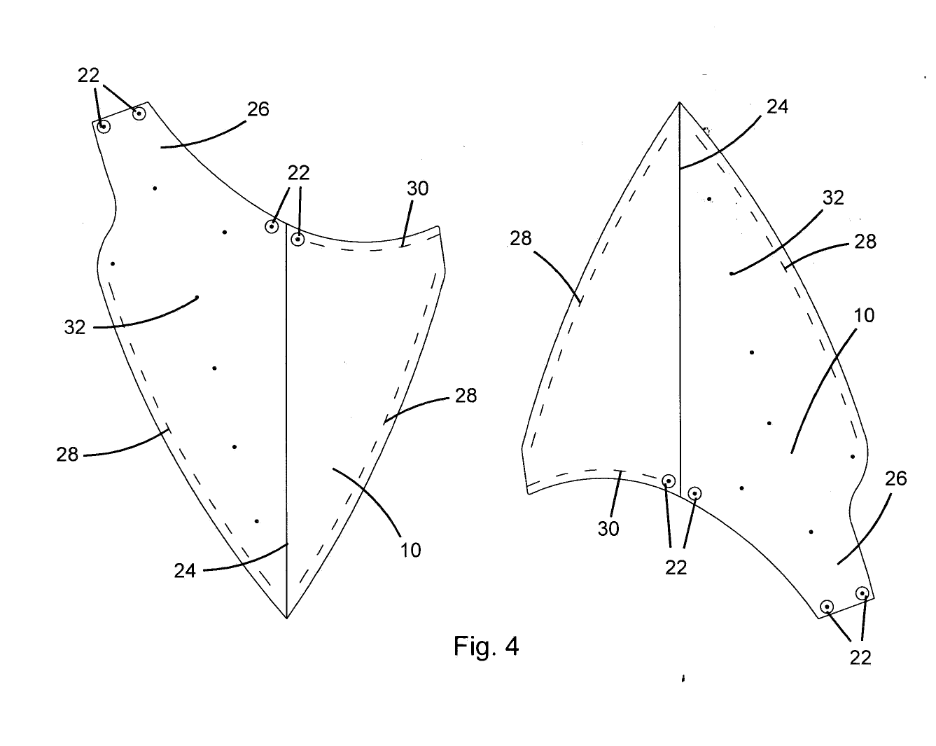

FIG. 4 shows the pattern to make the covering, which is not shown to scale.

To make the covering, cut two pieces of material according to the pattern shown in FIG. 4. Decorative items should be added to the material before the material is sewn or joined together. The decorative items can be placed anywhere on the covering as desired. Placement of the snaps 22 to secure the covering to the swan can be seen in FIG. 4.

FIG. 4 shows a right and left side of the covering. After embellishing the pieces of covering and inserting snaps, if used, place the two sides of the material inside out and sew along joining sew line 30. Sew approximately one quarter inch above the edge of the material for a length of approximately 2 inches. After sewing along joining sew line 30, turn the material so the outside is out to display the outside of the material. Fold along fold line 24 to form one half of the wing covering. Sew the sides of the covering together along joining sew line 30. Sew this seam one eighth of an inch from the edge. Repeat for the second wing. The cover is then slipped over the wings and secured in place by snaps 22.

It is also contemplated that additional head or body coverings may be included to enhance the covering.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A covering for a swan hood ornament, wherein the swan hood ornament has a pair of wings, and an abdomen comprising an item of clothing having an appearance, being dimensioned to match the dimensions of a swan hood ornament and the item of clothing being configured to match the shape of the swan hood ornament.

2. The covering for a swan hood ornament of claim 1 wherein the covering is secured to itself to cover the wings and abdomen of the hood ornament.

3. The covering for a swan hood ornament of claim 2 wherein the covering is secured to itself by means of snaps.

4. The covering for a swan hood ornament of claim 1, wherein the covering is made of material selected from the group consisting of: cotton, polyester, vinyl, vinyl coated polyester, truck tarp and awning material.

5. The covering for a swan hood ornament of claim 1, further comprising decorative items selected from the group consisting of: assorted nailheads, sequins, beads, buttons, decorative snaps, chains of appropriate gauge, and rhinestones.
